(19) United States
(12) Patent Application Publication
(10) Pub. No.: US 2022/0403123 A1
(43) Pub. Date: Dec. 22, 2022

(54) NON-CORRODING FIBER-REINFORCED POLYMER COMPOSITIONS

(71) Applicant: SAPPI Netherlands Services B.V., Maastricht (NL)

(72) Inventors: Michaël ALEXANDRE, Ougrée (BE); Ana Luisa MATOS VAZ, Maastricht (NL); Tina CELA, Herten (NL)

(73) Assignee: SAPPI Netherlands Services B.V., Maastricht (NL)

(21) Appl. No.: 17/777,314

(22) PCT Filed: Nov. 17, 2020
(86) PCT No.: PCT/EP2020/082396

§ 371 Date: May 17, 2022

(30) Foreign Application Priority Data
Nov. 18, 2019 (EP) 19209763.2

(51) Int. Cl. C08J 5/04; C08F 255/02; B29C 45/00

(52) U.S. Cl. CPC C08J 5/045; C08F 255/02; B29C 45/0001; C08J 2351/06; B29K 2023/06; B29K 2023/12

(57) ABSTRACT

The invention relates to an injection-molding composition comprising at least one polyolefin, at least one delignified wood pulp fiber, at least one maleic anhydride-grafted polyolefin and at least one metal oxide chosen from oxides of alkaline earth metals or of zinc.

### TECHNICAL FIELD

The present invention relates to fiber-reinforced polymer compositions that lead to less corrosion in metal molds into which they are injected in a molten state.

### PRIOR ART

Fiber-reinforced polymer composites are affordable materials that can be formed into a multitude of designs such as for example furniture, sport equipment or automotive parts. While in the past, mineral fibers such as glass fibers have been used in fiber-reinforced polymer composites, the use of plant-sourced fibers has increased in recent times because they also offer reinforcing properties without increasing density and are renewably sourced from plants.

The objects formed from fiber-reinforced polymer composites can be obtained via common molding techniques such as for example injection molding, where a melt of polymer composite is injected into a metal mold and left to solidify before being ejected.

Molds used in injection molding are generally expensive since their manufacture both requires significant work and expertise and the chemically inert metal alloys from which they are sometimes made of can be expensive. There is therefore an interest in maintaining the molds in use for as long as possible or to be able to use molds which are made of less resistant metal alloys.

When using wood fibers in polymer composites, it has been observed that the commonly used metal molds of injection molding machines suffer from increased corrosion on their inner surfaces when compared to levels of corrosion observed when using polymer composites reinforced with traditional mineral fibers.

While it is desirable to benefit from the reinforcing effects of the plant-sourced fibers, the market demands that they should not be overly visible in the molded object. Therefore, the plant-sourced fibers, which are generally sourced from wood, are at least chemically pulped to remove a substantial amount of wood lignin and in most cases also bleached in order to essentially remove any remaining lignin from the chemical wood pulp and obtain a white fiber that optically blends into the colored or uncolored polymer mass. An added benefit of this processing is that a very large fraction of lignin as well as a part of hemicellulose, which decompose into various unwanted corrosive acid compounds such as acetic and formic acid at molding temperatures, are removed from the plant-based material and mold life is extended.

However, using delignified wood pulps in polymer composites does not, as one would have expected, avoid mold corrosion. It is known to use additives such as for example hydrotalcite, that may act as acid scavengers,in polymer compositions comprising wood flour or wood fiber in an effort to mitigate corrosion of the mold. However, the addition of known acid scavengers such as hydrotalcite did not alleviate mold corrosion in the case of delignified wood pulps.

In addition, the delignified wood pulps in the polymer composite are hygroscopic and absorb moisture during open storage, and it has been observed that acquired moisture exacerbates, without being the direct cause of, corrosion problems in steel molds made of certain alloys.

There exists therefore a need to provide a solution to the problem of mold corrosion in the context of injection molding which occurs when forming objects out of polymer composites incorporating delignified wood pulps.

### SUMMARY OF THE INVENTION

The present invention provides for a composition, which when molded in a molten state in a metal mold such as a steel mold, leads at least to a diminution or to the elimination of otherwise unwanted corrosion of the metal molds. Further, invention provides for a composition that exhibits an extended storage life because the compositions of the present invention exhibit processing robustness in spite of high and variable acquired moisture levels. Without wishing to be held to a particular theory, it is assumed that the corrosion of the metal mold is due in part to corrosive compounds emanating from the delignified wood pulp fiber during conditions encountered in injection molding such as volatiles issued from the delignified wood pulp fiber thermal degradation or as chemical compounds which are introduced during the chemical delignification of the wood pulp and of which trace amounts and/or derivatives thereof, such as sulfur dioxide, are contained in the delignified wood pulp fiber.

It is an object of the present invention to provide a molding composition, preferably an injection-molding composition, comprising at least one thermoplastic polymer, at least one delignified wood pulp fiber, at least one maleic anhydride-grafted polyolefin and at least one metal oxide chosen from oxides of alkali metals or of alkaline earth metals or of zinc.

In a preferred embodiment of the molding composition according to the present invention, the molding composition has a melt flow index (MFI) of from 0.5 g/10 min to 40 g/10 min, when measured according to ASTM D 1238 at 190° C. using a 5 kg weight.

In the context of the present invention, the term “delignified wood pulp” is to be understood as referring to a wood pulp that is obtained by a process that reduces the lignin content. For example, delignified wood pulp may be obtained from any chemical pulping process in which the lignin content of the wood is substantially reduced such as for example, but not limited to, Kraft or sulfite pulping.

The thermoplastic polymer provides a matrix in which the delignified wood pulp fiber is dispersed. The at least one maleic anhydride-grafted polyolefin acts as a coupling agent that allows for a better adhesion between the matrix of thermoplastic polymer and the delignified wood pulp fiber, since the delignification of the wood pulp fiber renders the wood pulp fiber less compatible with the thermoplastic polymer.

In a preferred embodiment of the molding composition according to the present invention, the at least one polyolefin is present in an amount of from 10 weight percent to 85 weight percent, the weight percent being based on the total weight of the molding composition.

In a more preferred embodiment of the molding composition according to the present invention, the at least one polyolefin is present in an amount of from 55 weight percent to 75 weight percent, even more preferably of from 55 weight percent to 70 weight percent the weight percent being based on the total weight of the molding composition.

In a more preferred embodiment of the molding composition according to the present invention, the at least one polyolefin is present in an amount of from 20 weight percent to 50 weight percent, even more preferably of from 30 weight percent to 40 weight percent, the weight percent being based on the total weight of the molding composition.

In a preferred embodiment of the molding composition according to the present invention, the delignified wood pulp fiber is chosen from Kraft or sulfite pulp fiber and mixtures thereof.

In a more preferred embodiment of the molding composition according to the present invention, the delignified wood pulp fiber is Kraft pulp or bleached Kraft pulp fiber such as for example delignified hardwood pulp fiber.

In a more preferred embodiment of the molding composition according to the present invention, the delignified wood pulp fiber is sulfite pulp or bleached sulfite pulp fiber such as for example delignified hardwood pulp fiber.

In a preferred embodiment of the molding composition according to the present invention, the delignified wood pulp fiber is present in an amount of from 10 weight percent to 85 weight percent, the weight percent being based on the total weight of the molding composition.

In a more preferred embodiment of the molding composition according to the present invention, the delignified wood pulp fiber is present in an amount of from 15 weight percent to 45 weight percent, preferably in an amount of from 20 weight percent to 40 weight percent, the weight percent being based on the total weight of the molding composition.

In a preferred embodiment of the molding composition according to the present invention, the delignified wood pulp fiber is present in an amount of from 45 weight percent to 75 weight percent, preferably in an amount of from 55 weight percent to 65 weight percent, the weight percent being based on the total weight of the molding composition.

In a preferred embodiment of the molding composition according to the present invention, the delignified wood pulp fiber is delignified wood pulp fiber that has been obtained via an acidic pulping process.

In a preferred embodiment of the molding composition according to the present invention, the delignified wood pulp fiber is a dissolving wood pulp.

In a preferred embodiment of the molding composition according to the present invention, the delignified wood pulp fiber is at least partially derived from hardwood such as for example beech, birch, aspen, maple or eucalyptus.

In a preferred embodiment of the molding composition according to the present invention, the delignified wood pulp fiber is at least partially derived from softwood such as for example spruce or pine.

In a preferred embodiment of the molding composition according to the present invention, the delignified wood pulp fiber is a mixture of delignified hardwood pulp fiber sourced from for example beech, birch, aspen, maple or eucalyptus and delignified softwood pulp fiber sourced from for example spruce or pine.

In a preferred embodiment of the molding composition according to the present invention, the at least one maleic anhydride-grafted polyolefin, such as maleic anhydride-grafted polypropylene or maleic anhydride-grafted polyethylene, is present in an amount of from 0.5 weight percent to 5 weight percent, preferably in an amount of from 1 weight percent to 3 weight percent, the weight percent being based on the total weight of the molding composition.

In a preferred embodiment of the molding composition according to the present invention, the at least one maleic anhydride-grafted polyolefin, such as maleic anhydride-grafted polypropylene or maleic anhydride-grafted polyethylene, is present in an amount of from 2 weight percent to 15 weight percent, preferably in an amount of from 3 weight percent to 12 weight percent, the weight percent being based on the total weight of the delignified wood pulp fiber.

In a preferred embodiment of the molding composition according to the present invention, the at least one metal oxide is present in an amount of from 1 weight percent to 5 weight percent, the weight percent being based on the total weight of the molding composition.

In a preferred embodiment of the molding composition according to the present invention, the molding composition has a moisture content of more than 0.3 weight percent, preferably of from 0.5 to 2.5 weight percent, more preferably of from 1 to 1.5 weight percent when measured by Karl Fischer titration.

In a preferred embodiment of the molding composition according to the present invention, the molding composition comprises of from 0.5 to 1.5 weight percent, more preferably of from 0.8 to 1.2 weight percent of the at least one metal oxide per 0.2 weight percent of moisture when measured by Karl Fischer titration.

In a preferred embodiment of the molding composition according to the present invention, the at least one metal oxide is present in an amount of from 0.5 weight percent to 3 weight percent, the weight percent being based on the total weight of the molding composition.

In a preferred embodiment of the molding composition according to the present invention, the at least one metal oxide is chosen from calcium oxide, barium oxide, zinc oxide or magnesium oxide and more preferably is calcium oxide.

In a preferred embodiment of the molding composition according to the present invention, the at least one polyolefin is a polyethylene or polypropylene. Examples of the at least one polyolefin suitable in the context of the present invention are homopolypropylene, impact grade polypropylene copolymer, ethylene-propylene-copolymer.

In a more preferred embodiment of the molding composition according to the present invention, the molding composition may further comprise additives chosen from coloring agents, antioxidants, nucleating agents, foaming agents, UV-absorbers, light stabilizers, lubricants, impact modifiers, fillers, inorganic fibers such as glass or carbon fibers.

In a more preferred embodiment of the molding composition according to the present invention, the molding composition may be in the form of a salt and pepper blend of its ingredients, or as a solidified melt blend of its ingredients such as for example a pellet or in the form of a dimensionally stable agglomerate of its ingredients.

It is further an object of the present invention to provide a process for the production of a molded object, comprising the steps of injecting a melt of a composition according to the above into a mold made of steel, allowing the melt of the composition to cool and solidify in the mold made of steel, wherein the steel from which the steel mold is made comprises less than 11 weight % or even less than 3 weight % of chrome.

It is further an object of the present invention to provide a use of at least one metal oxide chosen from oxides of alkali metals or of alkaline earth metals or of zinc in a composition according to the above for avoiding corrosion in molds made of steel during injection molding, wherein the steel from which the steel mold is made comprises less than 11 weight of chrome or even less than 3 weight % of chrome..

Further embodiments of the invention are laid down in the dependent claims.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows a photograph of the unused and uncorroded mould before sample testing.

FIG. 2 shows a photograph of the mould after moulding of 80 parts, when using composition RC1 (neat PP, bleached sulphite hardwood pulp, coupling agent) having a moisture content below 0.5 wt %. No rust formation can be observed.

FIG. 3 shows a photograph of the mould after moulding of 20 parts, when using composition RC2 (neat PP, bleached sulphite hardwood pulp, coupling agent) having a moisture content of above 0.5 wt %. Slight rust formation can be observed.

FIG. 4 shows a photograph of the mould after moulding of 30 parts, when using composition RC3 (neat PP, bleached sulphite hardwood pulp, coupling agent) having a moisture content of above 1.5 wt %. Significant rust formation can be observed.

FIG. 5 shows a photograph of the mould after moulding of 30 parts, when using composition RC4 (neat PP, bleached sulphite hardwood pulp, coupling agent), which further includes hydrotalcite as acid scavenger, having a moisture content of above 0.5 wt %. Significant rust formation can be observed.

FIG. 6 shows a photograph of the mould after moulding of 80 parts, when using composition IC1 (neat PP, bleached sulphite hardwood pulp, coupling agent), which further includes CaO, having a moisture content of above 0.5 wt %. No rust formation can be observed.

FIG. 7 shows a photograph of the mould after moulding of 20 and 80 parts, when using composition RC5 (neat PP, Kraft-based dissolving hardwood pulp, coupling agent), having a moisture content of above 0.5 wt %. Slight rust formation can be observed.

FIG. 8 shows a photograph of the mould after moulding of 80 parts, when using composition IC2 (neat PP, Kraft-based dissolving hard wood pulp, coupling agent), which further includes CaO, having a moisture content of above 0.5 wt %. No rust formation can be observed.

### DESCRIPTION OF PREFERRED EMBODIMENTS

It is an object of the present invention to provide a molding composition comprising at least one thermoplastic polymer, at least one delignified wood pulp fiber, at least one maleic anhydride-grafted polyolefin and at least one metal oxide chosen from oxides of alkali metals or of alkaline earth metals or of zinc.

In a preferred embodiment, the molding composition comprises at least one polypropylene, at least one bleached sulfite pulp fiber, at least one maleic anhydride-grafted polypropylene and at least calcium oxide.

In a preferred embodiment, the molding composition comprises at least one polypropylene, at least one bleached Kraft pulp fiber, at least one maleic anhydride-grafted polypropylene and at least calcium oxide.

The molding composition may be obtained by any available method in which the components are combined. For example, the molding composition may be formed by combining a pre-blend of the least one thermoplastic polymer, the at least one delignified wood pulp fiber and the at least one maleic anhydride-grafted polyolefin with the at least one metal oxide in a melt blender or an extruder. The pre-blend may itself be obtained by blending the at least one thermoplastic polymer, the at least one delignified wood pulp fiber and the at least one maleic anhydride-grafted polyolefin in a K-Mixer or a thermokinetic mixer such as a Gelimat mixer or a vertical high-speed mixer, single or twin screw extruder or kneader such as to form a preferably particulate pre-blend.

Alternatively, the molding composition may be formed by combining the at least one thermoplastic polymer, the at least one delignified wood pulp fiber and the at least one maleic anhydride-grafted polyolefin with the at least one metal oxide in a K-Mixer or a vertical high-speed mixer, which are equipped with a hot stage and a cool stage (so-called hot-cold mixers). In this case, the at least one metal oxide is added to the other components preferably in the form of masterbatch, i.e. as a highly concentrated dispersion of metal oxide particles in polyolefin matrix. As an example a masterbatch may comprise of from 50 to 90 weight percent, preferably of from 65 to 85 weight percent of metal oxide dispersed in a thermoplastic polyolefin. In general, the resulting agglomerates can be used for injection molding as-is, or may be subsequently compacted in a compactor to yield granulates of said agglomerate or extruded or further compounded in a single or twin screw extruder to yield pellets. Additional compounding or extrusion of the aggregates may increase the homogeneity of the molding composition by more thoroughly mixing the individual components before pelletizing.

### EXAMPLES

Materials and Methods

Polypropylene P1 corresponds to polypropylene, obtainable from Braskem, Brazil under the trade designation Inspire 382, comprising maleic anhydride-grafted polypropylene as coupling agent, obtainable from BYK, Netherlands under the trade designation Priex 20097A.

Polypropylene P2 corresponds to polypropylene, obtainable from Sabic, Netherlands under the trade designation PP 579S, comprising maleic anhydride-grafted polypropylene as coupling agent, obtainable from BYK, Netherlands under the trade designation Priex 20097A.

Delignified wood pulp F1 used was bleached sulphite hardwood pulp.

Delignified wood pulp F2 used was Kraft-based dissolving hardwood pulp.

Calcium oxide used was a masterbatch of LDPE/CaO (30 wt %/70 wt %), introduced at 3 wt % during extrusion.

Hydrotalcite used was masterbatch designated QT00 12.708 from Qolortech (NL) introduced at 2 wt % during injection molding.

Compounds were prepared by extrusion to obtain compositions with about 40 wt % of delignified wood pulp and either 60 wt % of polypropylene (“neat” polypropylene+maleic anhydride-grafted polypropylene as a coupling agent) or 57 wt % polypropylene (“neat” polypropylene+maleic anhydride-grafted polypropylene as a coupling agent) and an additive such as for example 3 wt % CaO Masterbatch (i.e. 2.1 wt % CaO and 0.9 wt % LDPE) in case of IC1 and IC2. The exact compositions are provided in the below Table.

Samples were injection molded using constant standard injection moulding procedure in a circular mould equipped with a disk insert made from stainless steel 12/2312 (1.9% Cr) from Meusburger. The remainder of the mould, bushings and backplate are made from the same stainless steel.

The moisture uptake of the compositions was determined at the time the composition was injection-molded prior to introduction into the injection-molding device. Moisture uptake varied depending on storage conditions such as duration, relative humidity and temperature.

Compositions

| | Composition | | | | | | Moisture |
|---|---|---|---|---|---|---|---|
| | P1 | P2 | F1 | F2 | Hydrotalcite | CaO | uptake |
| Samples | (wt %) | (wt %) | (wt %) | (wt %) | (wt %) | (wt %) | (wt %) |
| Reference | | 60 | 40 | | | | 0.3 |
| compound | | | | | | | |
| 1 (RC1) | | | | | | | |
| Reference | 60 | — | 40 | — | — | — | 0.7 |
| compound | | | | | | | |
| 2 (RC2) | | | | | | | |
| Reference | 60 | — | 40 | — | — | — | 1.7 |
| compound | | | | | | | |
| 3 (RC3) | | | | | | | |
| Reference | 58.8 | — | 39.2 | — | 2 | — | n.d. |
| compound | | | | | | | (above |
| 4 (RC4) | | | | | | | 0.5) |
| Reference | — | 60 | — | 40 | — | — | 1.1 |
| compound | | | | | | | |
| 5 (RC5) | | | | | | | |
| Inventive | 57, and | — | 40 | — | — | 2.1 | 2.3 |
| compound | 0.9 | | | | | | |
| 1 (IC1) | LDPE | | | | | | |
| Inventive | — | 57, and | — | 40 | — | 2.1 | 1.1 |
| compound | | 0.9 | | | | | |
| 2 (IC2) | | LDPE | | | | | |

Results

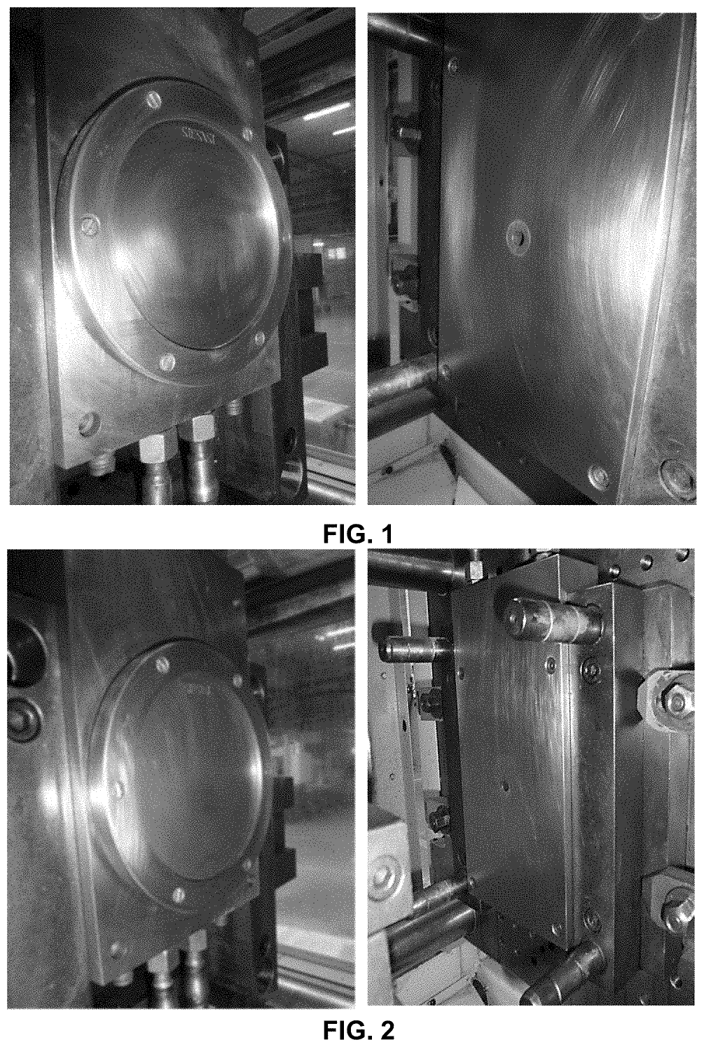

The surface state of the mould was inspected every 10 injected parts and photographs were made to record the occurrence of rust as brown deposits or corrosion pitting. The photographs are shown in FIGS. 1 to 8.

As can be seen from the Figures, when corrosion occurs, it is mainly seen at the inner and outer periphery of the mould, and especially also on the back plate.

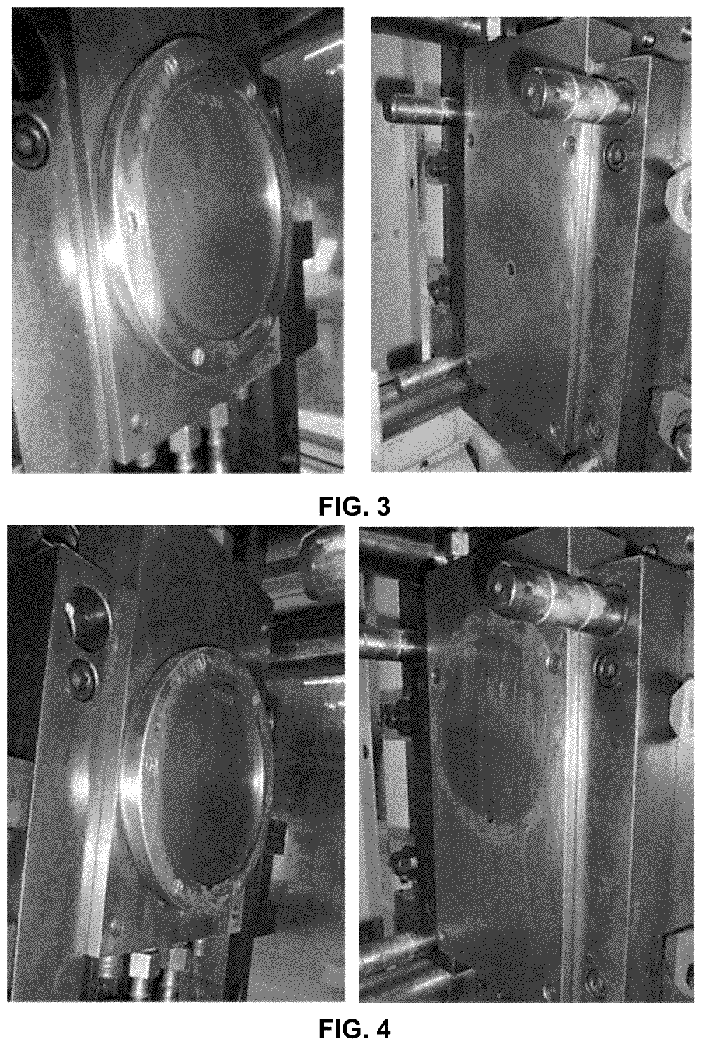

From FIG. 2, it is apparent that the compositions of polypropylene and delignified wood pulp (RC1), when dried to a moisture content of 0.3 wt %, i.e. less than 0.5 wt %, do not lead to rust formation even after 80 parts are injection molded. In FIG. 3, for a composition that is essentially the same as RC1 except for the fact that the moisture content is 0.7 wt % i.e. above 0.5 wt % (RC2), already light corrosion is observed after 20 parts are injection molded. Much stronger corrosion is observed in FIG. 4 for compound RC3, which is the same as RC2 except for the fact that the moisture content is 1.7 wt % i.e. even more above 0.5 wt %, corroborating the concept that water contents above 0.5 wt % enable corrosion caused when injection moulding compounds comprising polyolefins and delignified wood pulp.

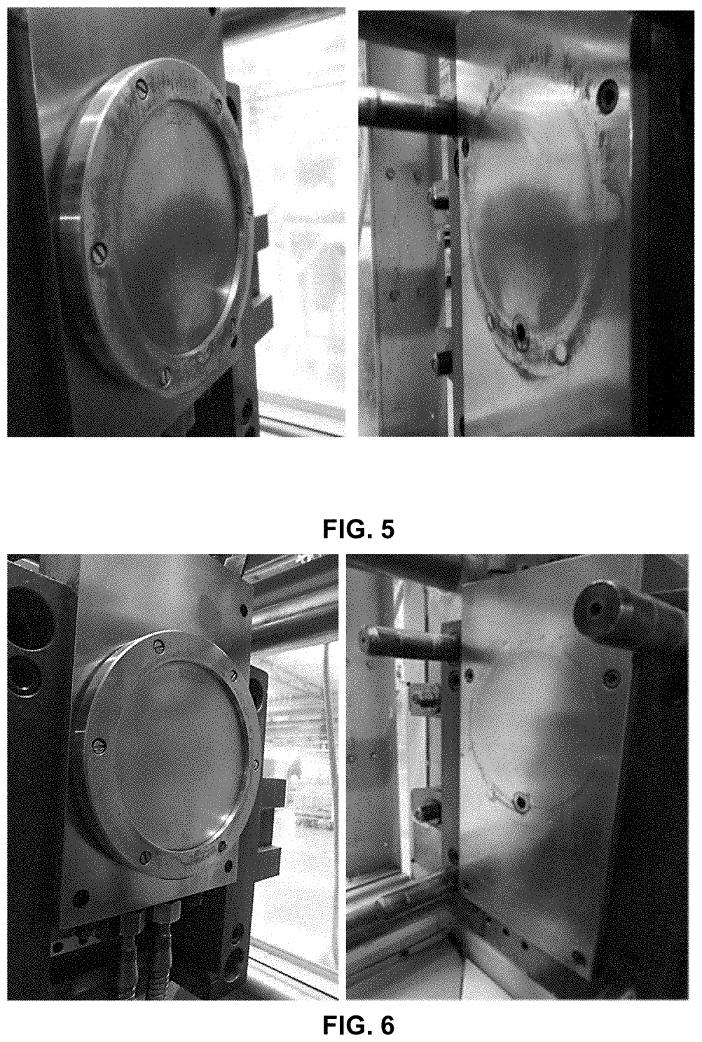

As is apparent from FIG. 5, the introduction of a standard acid scavenger (hydrotalcite) in RC4 (moisture content >0.5 wt %) does lead to a reduction of the rust formation.

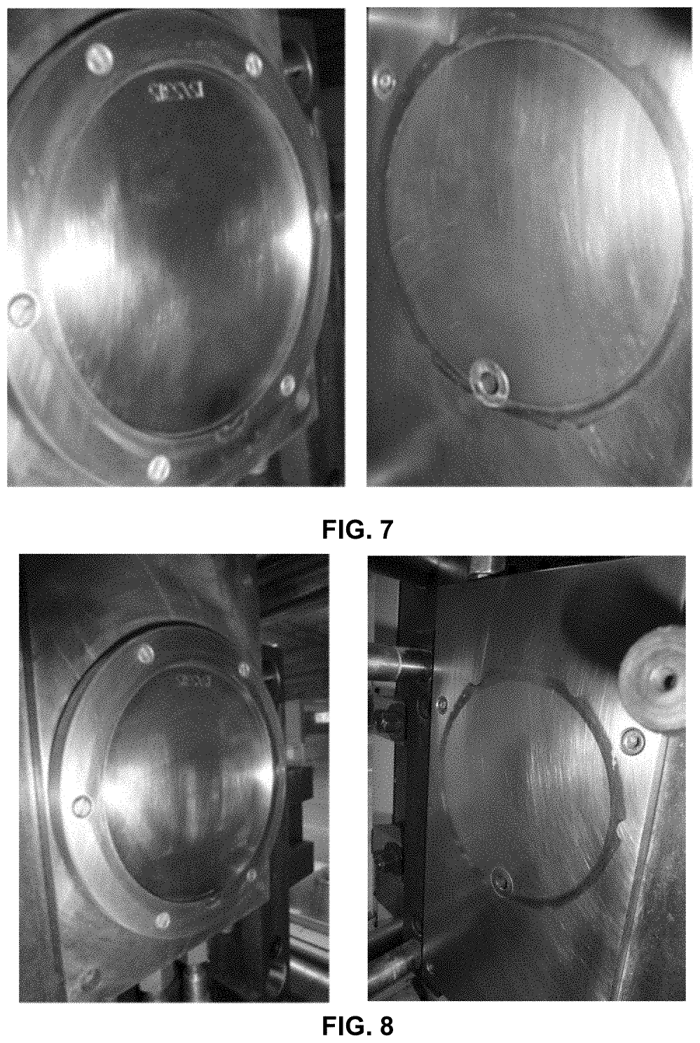

Shifting from a bleached sulphite wood pulp fibre to a Kraft-based dissolving wood pulp (RC5) that contains essentially no residual lignin and much lower amount of hemicellulose significantly reduces the amount of mould corrosion, as seen in FIG. 7, without however eliminating it completely. Only the introduction of a basic metal oxide like calcium oxide in IC1 (bleached sulphite pulp) or IC2 (Kraft-based dissolving wood pulp) allows to completely suppress mould corrosion even at moisture contents in excess of 0.5 wt% (FIG. 6 and FIG. 8, respectively), as evaluated after the injection of 80 parts.

### LIST OF REFERENCE SIGNS

none

1. An injection-molding composition comprising at least one polyolefin, at least one delignified wood pulp fiber, at least one maleic anhydride-grafted polyolefin and at least one metal oxide chosen from oxides of alkaline earth metals or of zinc.

2. The injection-molding composition according to claim 1, wherein the at least one polyolefin is present in an amount of from 10 weight percent to 85 weight percent, the weight percent being based on the total weight of the injection-molding composition.

3. The injection-molding composition according to claim 1, wherein the delignified wood pulp fiber is present in an amount of from 10 weight percent to 85 weight percent, the weight percent being based on the total weight of the injection-molding composition.

4. The injection-molding composition according to claim 1, wherein the delignified wood pulp fiber is sulfite pulp.

5. The injection-molding composition according to claim 1, wherein the at least one maleic anhydride-grafted polyolefin, is present in an amount of from 2 weight percent to 15 weight percent, the weight percent being based on the total weight of the delignified wood pulp fiber.

6. The injection-molding composition to claim 1, wherein the at least one metal oxide is present in an amount of from 0.5 weight percent to 5 weight percent, the weight percent being based on the total weight of the injection-molding composition.

7. The injection-molding composition according to claim 1, having a moisture content of more than 0.5 wt % when measured by Karl Fischer titration.

8. The injection-molding composition according to claim 1, wherein the at least one metal oxide is present in an amount of from 1 weight percent to 3 weight percent, the weight percent being based on the total weight of the injection-molding composition.

9. The injection-molding composition according to claim 1, wherein the at least one metal oxide is chosen from calcium oxide, barium oxide, zinc oxide or magnesium oxide.

10. The injection-molding composition according to claim 1, wherein the at least one polyolefin is a polyethylene or polypropylene.

11. The injection-molding composition according to claim 1, wherein the at least one polyolefin is an impact polypropylene copolymer.

12. (canceled)

13. A process for the production of a molded object by injection-molding, comprising the steps of:
a. forming a precursor agglomerate of at least one thermoplastic polymer, at least one delignified wood pulp fiber, at least one maleic anhydride-grafted polyolefin and at least one metal oxide chosen from oxides of alkali metals or of alkaline earth metals,
b. processing the precursor agglomerate into a melt and optionally to increase the dispersion of the delignified wood pulp fiber,
c. introducing, the molten composition into a mold made of steel, and
allowing the melt of the composition to cool and solidify in the mold made of steel, wherein the steel from which the steel mold is made comprises less than 11% of chrome.

14. The injection-molding composition according to claim 1, wherein the at least one metal oxide is calcium oxide.

15. The process for the production of a molded object by injection-molding according to claim 13, wherein the molten composition is introduced into the mold made of steel by injecting it into the mold made of steel.

16. The injection-molding composition according to claim 1, wherein the at least one maleic anhydride-grafted polyolefin is maleic anhydride-grafted polypropylene or maleic anhydride-grafted polyethylene, and is present in an amount of from 2 weight percent to 15 weight percent, the weight percent being based on the total weight of the delignified wood pulp fiber.
